(19) United States
(12) Patent Application Publication
(10) Pub. No.: US 2001/0023406 A1
(43) Pub. Date: Sep. 20, 2001

(54) System and method for personalizing a mailer

(76) Inventors: David Engel, Toronto (CA); Mark Sadowski, Toronto (CA)

Correspondence Address: MERCHANT & GOULD PC, P.O. BOX 2903, MINNEAPOLIS, MN, 55402-0903, US

(21) Appl. No.: 09/774,224

(22) Filed: Jan. 30, 2001

(30) Foreign Application Priority Data
Feb. 1, 2000 (CA) 2,297,569

(51) Int. Cl. G06F 17/60

(52) U.S. Cl. 705/14

(57) ABSTRACT

A system for personalizing a mailer includes a controller receiving information identifying the intended recipient of the mailer. In response to this information, the controller selects information to be printed on the exterior of the mailer, with the information to be printed being personalized for the intended recipient. A printer is responsive to the controller to print the personalized information on the back exterior surface of the mailer. A method for personalizing a mailer is also disclosed.

### FIELD OF THE INVENTION

The present invention relates generally to the preparation of mailers and in particular to a system and method for personalizing the back exterior surface of mailers.

1. Background of the Invention

As is well known, many businesses are required to mail letters directly to addressees. For example, credit card companies, financial institutions, utilities etc. typically send statements and/or bills to their customers each month. Advertising houses also mail advertisements, promotional material etc. to addressees on a regular basis. In the past, envelopes accommodating these materials have been void of variable printed information and have served a single purpose, namely to act a carrier for the materials to be delivered.

Direct mailing is expensive and therefore it is desirable from an economic standpoint to achieve more than one goal at the same time. To increase the value of direct mailing, institutions issuing statements and/or bills often include inserts promoting the businesses' products and/or services with the statements and/or bills. In most cases the inserts are generic in nature and are included with each statement.

Significant research has been conducted on the effectiveness of advertising and it has been found that generic advertising, although useful, achieves only limited success. Personalizing advertising has been found to increase the effectiveness of the advertising and better draw the attention of the recipient to the advertising. Accordingly, improvements in the preparation of mailers are desired.

It is therefore an object of the present invention to provide a novel system and method for personalizing the back exterior surface of mailers.

2. Summary of the Invention

According to one aspect of the present invention there is provided a method for personalizing mailers comprising the steps of:

selecting information to be printed on mailers based on data relating to intended recipients of said mailers, said information varying depending on said intended recipients; and

printing the information on a back exterior surface of said mailers.

Preferably, the method further includes the step of capturing recipient identification data from each mailer that is used to select the information to be printed on the mailers. The recipient identification data may include at least one of the intended recipient's name, address, postal code, and a customer identification code assigned to the intended recipient. In one embodiment, the recipient identification data is printed on an item within each mailer. The recipient identification data may be captured from the item prior to the item being placed in a carrier envelope or may be captured from the item through a window of a carrier envelope into which the item is placed.

Preferably, the method further includes the step of comparing the recipient identification data captured from each mailer with recipient identification data stored in at least one database to identify the intended recipient. It is also preferred that the selecting step includes the step of retrieving personalized information from the at least one database relevant to the intended recipient. The retrieving step may include the step of selecting a message template from the at least one database based on personal data stored in the at least one database that is associated with the identified intended recipient thereby to create the personalized information to be printed on each mailer. Additionally, the retrieving step may include the step of modifying the selected message template using the personal data.

According to another aspect of the present invention there is provided a method for personalizing a mailer comprising the steps of:

identifying the intended recipient of a mailer;

preparing information to be printed on said mailer, said information being personalized for said intended recipient; and

printing the personalized information on a back exterior surface of said mailer.

According to yet another aspect of the present invention there is provided a system for personalizing a mailer comprising:

a controller receiving information identifying the intended recipient of said mailer and in response thereto, selecting information to be printed on the exterior of said mailer, said information being personalized for said intended recipient; and

a printer responsive to said controller for printing the personalized information on a back exterior surface of said mailer.

The present invention provides advantages in that the back exterior surface of mailers are printed with information that is personalized for the intended recipients prior to mailing. As a result, the typically unused back exterior surface of the mailers serves a useful purpose and the effectiveness of advertising printed on the back exterior surface of the mailers is increased.

### BRIEF DESCRIPTION OF THE DRAWINGS

A preferred embodiment of the present invention will now be described more fully with reference to the accompanying drawings in which:

FIG. 1 is a schematic diagram of a system for preparing mailers that are personalized for intended recipients;

FIG. 2 is a flow chart showing the steps performed during preparation of the mailers; and

FIGS. 3a and 3b are elevational views of personalized mailers prepared by the system of FIG. 1.

### DETAILED DESCRIPTION OF THE PREFERRED EMBODIMENT

The present invention relates generally to a method and system for personalizing mailers for intended recipients. Personalizing within the context of the present invention refers to the selection of printed information for an intended recipient or group of intended recipients. The printed information selected for the intended recipient or group of intended recipients may be generic or may be modified to reference personal data associated with the intended recipient or group of intended recipients.

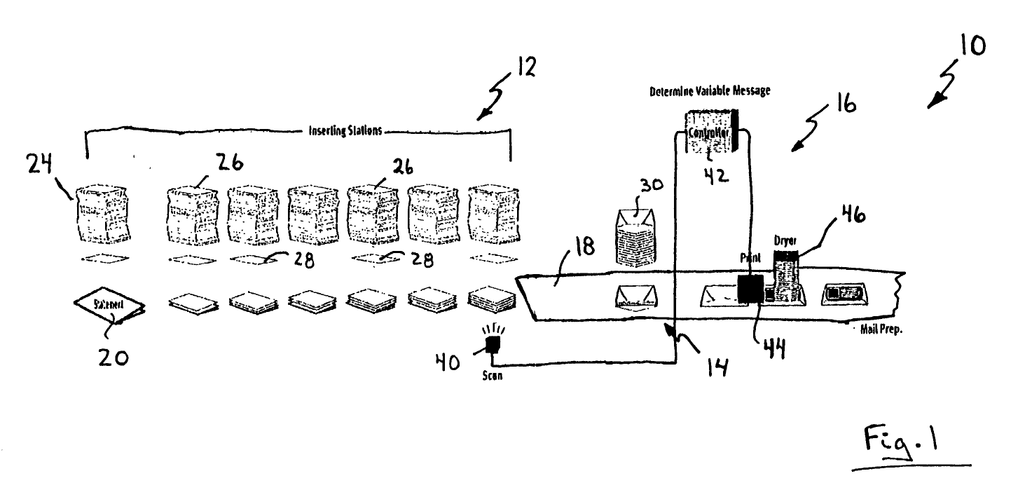

Turning now to FIG. 1, a system for personalizing mailers for intended recipients is shown and is generally identified by reference numeral 10. As can be seen, system 10 includes an insert line 12, an envelope stuffing and sealing station 14 downstream of the insert line 12 and a mailer customization station 16 downstream of the envelope stuffing and sealing station 14. A heat-resistant ink-jet vacuum conveyor 18 such as that manufactured by Packsmart carriers collated statements and inserts exiting the insert line 12 to the envelope stuffing and sealing and mailer customization stations 14 and 16 respectively.

In the present embodiment, insert line 12 collates statements such as those issued by financial institutions, credit card companies, utilities and the like with one or more inserts. Each statement 20 has information identifying the intended recipient of the statement printed on it. The recipient information in this case includes the name, address and postal (“zip”) code of the intended recipient, as well as a customer identification (ID) code assigned to the intended recipient by the institution issuing the statement.

Insert line 12 includes a plurality of insert stations 26 arranged in series. One insert station 24 holds the statements while the remaining insert stations 26 hold different types of inserts 28. Each insert station 26 is operable to place an insert on a statement passing beneath it, if the insert is considered appropriate for the intended recipient of the statement.

The envelope stuffing and sealing station 14 receives each statement and accompanying inserts exiting the insert line 12 and stuffs the statement and accompanying inserts into an envelope 30. The envelope stuffing and sealing station 14 then seals the stuffed envelope to complete the mailer. The insert line 12 and the envelope stuffing and sealing station 14 are well known in the art and therefore, further specifics will not be described herein.

Mailer customization station 16 includes a scanner 40 positioned adjacent the last insert station 26 in the insert line 14, a controller 42 communicating with the scanner, a printer 44 responsive to the controller 42 and a dryer 46 downstream of the printer 44. In the present embodiment, the printer 44 is of the type manufactured by Scitex under model No. Dijit 5300 and includes an S120 data station and an S2 fluid controller. The dryer 46 is of the type manufactured by Fannon Products under model No. Lightspeed LSL-240-3-16.

The scanner 40 in this embodiment is in the form of a bar code reader such as that manufactured by Accusort under model No. Accu Vision AV20. Scanner 40 reads the customer ID code printed on each statement exiting the insert line 12 and communicates the captured customer ID code to the controller 42.

Controller 42 includes a data processing unit hosting a file management system (FMS) to maintain and access a database storing personalized information to be printed on the mailers prior to mailing thereby to personalize the mailers. Data processing unit also hosts a finishing control system (FCS) to ensure that the proper personalized information is printed on each mailer. The data processing unit is preferably located in an environmentally controlled room remote from the insert line 12 and envelope stuffing and sealing station 14 to avoid exposure to the dusty environment. Controller 42 also includes a remote printer control (RPC) to drive the printer. In the present embodiment, the FMS, FCS and RPC are manufactured by Quad Tech International.

The personalized information stored in the database is partitioned into two sections. One section includes a plurality of message templates while the other section includes personal data associated with the intended recipients. The personal data is used to select and modify, if appropriate, the message templates so that the personalized information printed on each mailer is relevant to the intended recipient of the mailer.

The message templates may relate to virtually any subject such as advertising to promote services and/or products of the statement issuing institution. Alternatively, the message templates may relate to affiliates of the statement issuing institution.

The recipient personal data may vary from a high degree of personalization to a low degree of personalization. For example, the recipient personal data may include the names of the intended recipients, their genders, home and/or business locations and/or their interests. This data can be used to select and modify the text of a message template or can simply be used to select a message template.

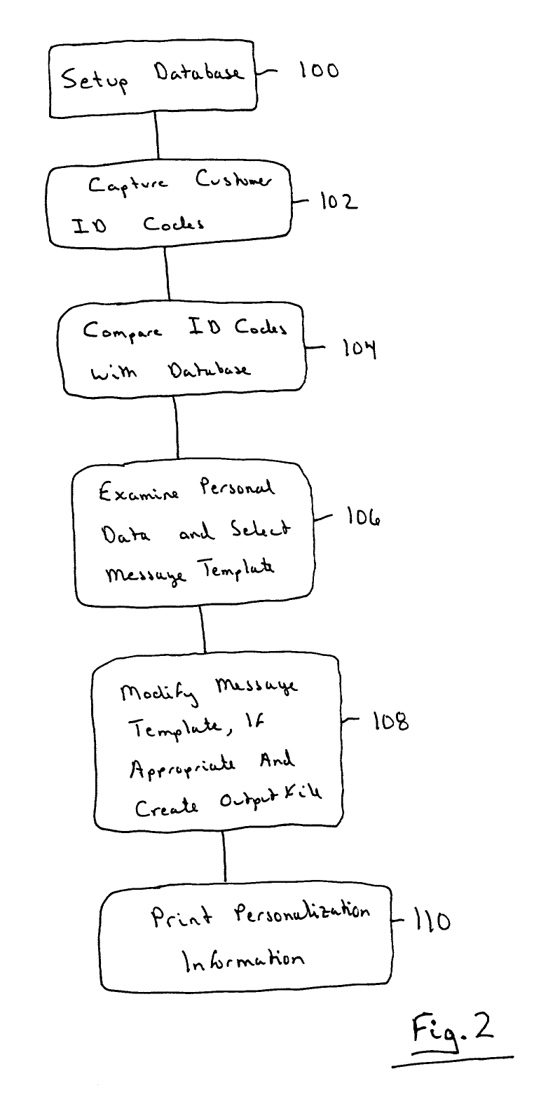

The operation of system 10 will now be described with particular reference to FIG. 2. Initially the database must be set up so that the personalized information printed on each mailer is appropriate for the intended recipient (step 100). During this set up stage, the customer ID codes assigned to the intended recipients, the personal data associated with the intended recipients and the degree of personalization selected for each intended recipient is loaded into the database. With the database set up in this manner, the appropriate personalized information to be printed on each mailer can be generated.

Once the database is set up, the system 10 is ready for operation. During operation, the insert line 12 collates statements 20 and inserts 28 that are relevant to the intended recipients and delivers the statements and accompanying inserts at intervals to the conveyor 18. The conveyer 18 in turn carries each statement and accompany inserts to the envelope stuffing and sealing station 14. At the envelope stuffing and sealing station, the statements and inserts are stuffed into an envelope and the envelope is sealed.

When each statement reaches the last insert station in the insert line 12, the scanner 40 captures the customer ID code from the statement and communicates the customer ID code to the data processing unit of the controller 42 (step 102). Upon receipt of the customer ID code, the data processing unit compares the captured customer ID code with the customer ID codes in the database (step 104). The data processing unit then examines the personal data associated with the identified intended recipient and selects the appropriate message template from the database that has been pre-selected for the intended recipient (step 106). The data processing unit in turn modifies the message template using the personal data, if appropriate, and creates an output file including the personalized information to be printed onto the mailer (step 108).

As each mailer exits the envelope stuffing and sealing station 14, the conveyor 18 carries the mailer to the printer 44. When the mailer arrives at the printer 44, the data processing unit outputs the file holding the personalized information to RPC. The RPC in turn drives the printer 44 so that the appropriate personalized information is printed on the back exterior surface of the mailer (step 110). Once printed, the mailer is conveyed to the dryer 46 to dry the printed ink. At this stage, the mailer is ready for mailing and carries advertising or other information on the back exterior surface of the mailer that has been personalized for the intended recipient.

The FCS determines whether any unexpected gaps exist in the delivery of mailers from the envelope sealing and stuffing station 14 to the printer 44 so that personalized information intended for one recipient is not printed on a mailer intended for another recipient.

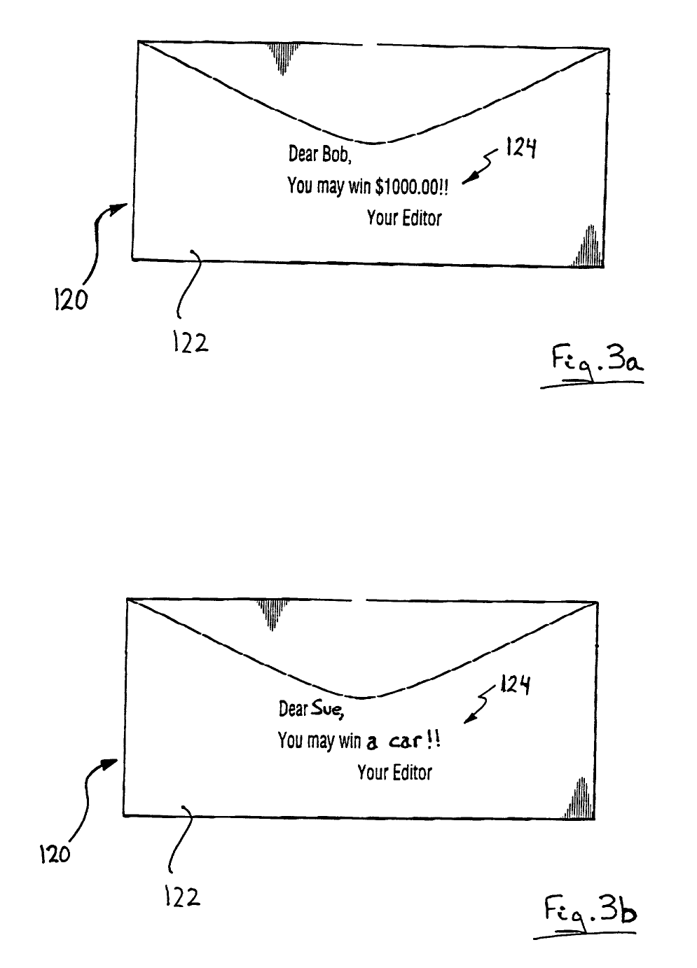

FIGS. 3a and 3b show mailers 120 prepared by the system 10. As can be seen, the back exterior surface 122 of each mailer 120 is printed with personalized information 124 relevant to the intended recipient of the mailer. In this example, the message template “Dear ______ , You may win !! Your Editor” has been personalized to identify the first names of the intended recipients and awards believed to be of personal value to the intended recipients.

As will be appreciated, by using data relating to the intended recipients of mailers, variable information can be printed on the back exterior surface of the mailers. This allows the mailers to be printed with information believed to be relevant to the intended recipients increasing the effectiveness of the information.

Although the scanner 40 has been described as being positioned adjacent the last insert station 26 in the insert line 12, those of skill in the art will appreciate that the scanner may be positioned before, after, or anywhere along the insert line where it is convenient to read the customer ID code from the statement. Also, if the envelopes are of the window-type, the scanner 40 may also be positioned at, or after the envelope stuffing and sealing station 14 provided the customer ID codes are placed on the statements at locations where they are visible through the windows. Of course, if the customer ID codes are printed on the envelopes, the scanner may be positioned at, or after the envelope stuffing and sealing station 14.

Although the scanner 40 has also been described as a bar code reader, those of skill in the art will appreciate that other vision systems may be used to capture information from the statement or carrier envelope to enable data relating to the intended recipient of the mailer to be captured. For example, camera systems can be used to capture the name, address and/or postal code of the intended recipient.

Those of skill in the art will also appreciate that different databases can be used to hold the message templates and personal data. As mentioned previously, the level of personalization of the personalized information printed on the mailers may vary from a high degree of personalization where the intended recipient is identified by name or a low degree of personalization where a generic message template is selected that includes information relevant to the recipient's gender, home or business location, etc.

Although the mailer customization station 16 has been shown and described in-line with the insert and envelope stuffing and sealing stations 12 and 14 respectively, the mailer customization station 16 can be positioned off-line. In this manner, stuffed and sealed envelopes can be processed at a location remote from the insert and envelope stuffing and sealing stations.

Those of skill in the art will also appreciate that the present system and method can be used to personalize the back exterior surfaces of mailers issued by advertising houses and other direct mailing sources to enhance recipients interest in the content of the mailers.

Although a preferred embodiment of the present invention has been described, those of skill in the art will appreciate that modifications and variations may be made without departing from the spirit and scope thereof as defined by the appended claims.

We claim:

1. A method for personalizing mailers comprising the steps of:
selecting information to be printed on mailers based on data relating to intended recipients of said mailers, said information varying depending on said intended recipients; and
printing the information on back exterior surfaces of said mailers.

2. The method of claim 1 further comprising the step of capturing recipient identification data from each mailer, said recipient identification data being used to select the information to be printed on said mailers.

3. The method of claim 2 wherein said recipient identification data includes at least one of an intended recipient's name, address, postal code and a customer identification code assigned to said intended recipient.

4. The method of claim 3 wherein said recipient identification data is captured from an item within each mailer prior to said item being placed in a carrier envelope.

5. The method of claim 3 wherein said recipient identification data is captured from an item within each mailer through a window of a carrier envelope into which said item is placed.

6. The method of claim 2 further comprising the step of comparing the recipient identification data captured from each mailer with recipient identification data stored in at least one database to identify the intended recipient and wherein said selecting step includes the step of retrieving personalized information from said at least one database relevant to the intended recipient.

7. The method of claim 6 wherein said retrieving step includes the step of selecting a message template from said at least one database based on personal data stored in said at least one database that is associated with said identified intended recipient thereby to create the personalized information to be printed on each mailer.

8. The method of claim 7 wherein said retrieving step further comprises the step of modifying the selected message template using said personal data.

9. A method for personalizing a mailer comprising the steps of:
identifying the intended recipient of a mailer;
preparing information to be printed on said mailer, said information being personalized for said intended recipient; and
printing the personalized information on a back exterior surface of said mailer.

10. The method of claim 9 wherein said identifying step includes the step of capturing recipient identification data from said mailer, said recipient identification data including at least one of an intended recipient's name, address, postal code and a customer identification code assigned to said intended recipient.

11. The method of claim 10 wherein said recipient identification data is captured from an item within said mailer prior to said item being placed in a carrier envelope.

12. The method of claim 10 wherein said recipient identification data is captured from an item within said mailer through a window of a carrier envelope into which said item is placed.

13. The method of claim 10 further comprising the step of comparing the captured recipient identification data with recipient identification data stored in at least one database to identify the intended recipient and wherein said preparing step includes the step of retrieving personalized information from said at least one database relevant to the intended recipient.

14. The method of claim 13 wherein said retrieving step includes the step of selecting a message template from said at least one database based on personal data stored in said at least one database that is associated with said identified intended recipient thereby to create the personalized information to be printed on said mailer.

15. The method of claim 14 wherein said retrieving step further comprises the step of modifying the selected message template using said personal data.

16. A system for personalizing a mailer comprising:
a controller receiving information identifying the intended recipient of said mailer and in response thereto, selecting information to be printed on the exterior of said mailer, said information being personalized for said intended recipient; and
a printer responsive to said controller for printing the personalized information on a back exterior surface of said mailer.

17. The system of claim 16 further including a scanner for capturing recipient identification data from said mailer and conveying said recipient identification data to said controller.

18. The system of claim 17 wherein said recipient identification data is at least one of an intended recipient's name, address, postal code and a customer identification code assigned to said intended recipient.

19. The system of claim 18 wherein said scanner captures said recipient identification data from an item within said mailer prior to said item being placed in a carrier envelope.

20. The system of claim 18 wherein said controller includes a data processing unit and at least one database storing recipient identification data identifying each intended recipient and personal data associated with each intended recipient, said data processing unit comparing captured recipient identification data with recipient identification data stored in said at least one database to determine the intended recipient and selecting the personalized information based on the personal data associated with the intended recipient.

21. The system of claim 20 wherein said at least one database stores a plurality of message templates, said data processing unit using said personal data to modify message templates and thereby generate said personalized information.
